(19) United States
(12) Patent Application Publication
(10) Pub. No.: US 2018/0025825 A1
(43) Pub. Date: Jan. 25, 2018

(54) Temperature-Compensated Valve

(71) Applicant: Eagle Actuator Components GmbH & Co. KG, Weinheim (DE)

(72) Inventors: Ralf Heinrich, Schwegenheim (DE); Daniel Koch, Edingen-Neckarhausen (DE); Siegfried Driemer, Fürth (DE)

(73) Assignee: Eagle Actuator Components GmbH & Co. KG, Weinheim (DE)

(21) Appl. No.: 15/651,971

(22) Filed: Jul. 17, 2017

(30) Foreign Application Priority Data
Jul. 19, 2016 (DE) 10 2016 113 313.2

(51) Int. Cl. H01F 7/18; H01F 7/16; F16K 31/06

(52) U.S. Cl. CPC H01F 7/18; F16K 31/0675; H01F 7/1607

(57) ABSTRACT

A valve is provided having a circuit that includes an electrical conductor with a temperature-dependent electrical resistance. The electrical conductor is connected in series to an electrical series resistor, which includes a parallel circuit of an ohmic resistor and an NTC resistor. The electrical conductor includes a coil wire wound into a magnetic coil that is operable to move an armature to open or close the valve. The effect of the operation of the valve itself on the magnetic force of the coil is minimized by arranging the NTC resistor to be thermally coupled with the coil wire.

### CROSS-REFERENCE TO RELATED APPLICATION(S)

This application claims priority under 35 U.S.C. §119 to: German Patent Application No. 10 2016 113 313.2, filed on Jul. 19, 2016, which is herein incorporated by reference.

### TECHNICAL FIELD

The present disclosure relates to a valve having a circuit with temperature compensation.

### BACKGROUND

A temperature-compensated valve is known, for example, from WO 2015/161 910 A1. The valve has a circuit with an NTC resistor in order to compensate for influences of temperature on the magnetic force of its coil. The magnetic force of the coil is dependent on the electric current. In the case of the voltage-controlled operation of the coil, this current, in turn, depends primarily on the electrical resistance of the wound coil wire. As the temperature increases, this electrical resistance rises, thereby reducing the current and weakening the magnetic force of the coil.

It is known from WO 2015/ 161 910 A1 that very different ambient temperatures exist in engine compartments of motor vehicles depending on the ambient and operating conditions, which can have an influence on the electrical resistance of the coil wire.

There are in fact also other influences reducing the magnetic force of the coil when the valve is being operated. The current that is conducted through the coil wire also results in the heating of the coil wire.

Therefore the disclosure is directed to providing a valve with which influences on the magnetic force of its coil that are caused by the operation of the valve itself can be effectively and quickly minimized and/or compensated for.

### SUMMARY

In accordance with the disclosure, a valve is provided having a circuit that includes an electrical conductor with a temperature-dependent electrical resistance. The electrical conductor is connected in series to an electrical series resistor, which includes a parallel circuit of an ohmic resistor and an NTC resistor. The electrical conductor includes a coil wire thermally coupled to the NTC resistor.

### BRIEF DESCRIPTION OF THE DRAWINGS

The features, aspects, and advantages of the present disclosure will become better understood with regard to the following description, appended claims, and accompanying drawings where:

FIG. 1 shows a circuit in which a coil is connected in series with a parallel circuit of ohmic resistor and NTC resistor,

FIG. 2 shows a schematic representation of a valve in which the circuit according to FIG. 1 is implemented,

FIG. 3 shows a diagram in which the temperature dependence of the electrical resistance of the coil and of the overall electrical resistor of coil and parallel circuit is illustrated,

FIG. 4 shows four perspective views of a magnetic circuit with an NTC resistor and a coil formed by a coil wire,

FIG. 5 shows four perspective, partially cutout views of the magnetic circuit according to FIG. 4, although it is provided with a plastic casing here, and

FIG. 6 shows a partially cutout and perspective view of a valve with temperature compensation.

### DETAILED DESCRIPTION OF ILLUSTRATIVE EMBODIMENTS

According to the disclosure, the increase in the electrical resistance of a conductor is compensated for as a result of the decrease in the electrical resistance of a series resistor. As a result, the total resistance of electrical conductor and series resistor can be maintained approximately constant over a defined temperature range.

According to the disclosure, it was recognized that it is particularly the current that is conducted through the wound coil wire that results in the rapid heating of the coil wire and to a rapid increase in the electrical resistance thereof. The NTC resistor is therefore arranged so as to be thermally coupled with the coil wire.

It was recognized in this regard that the maximally immediate proximity of the NTC resistor to the warm coil wire can be exploited in order to influence the NTC resistance very quickly in a suitable manner. The NTC resistor then compensates nearly without a time-delay for the change in resistance associated with the heating of the coil wire.

Surprisingly, it was recognized that the heat of an automobile engine has less influence on the NTC resistance than even the occasional operation of the coil, particularly clocked operation or use of the coil only in defined intervals.

It was recognized in this respect that it is sometimes less the ambient temperature of the valve that must be compensated for than the temperature of the coil wire itself.

A quick reaction to a heat-induced change in resistance in the coil wire is possible according to the disclosure. This results in a substantially reduced reaction time for the temperature compensation by the circuit. It is thus the relevant temperature of the coil wire that is compensated for and not necessarily, or only secondarily, the ambient temperature.

A valve is thus provided with which influences on the magnetic force of its coil that are caused by the operation of the valve itself can be effectively and quickly minimized and/or compensated for.

The NTC resistor can be spaced apart 0.5 to 1 mm from the coil wire. This distance from the wound coil wire has proven to be especially suitable in order to establish thermal coupling. Preferably, the NTC resistor is spaced apart radially and/or axially from a winding of the coil wire in the abovementioned spacing interval.

The NTC resistor can be integrated into a plastic casing of a magnetic circuit. The plastic has the effect of providing good heat conduction and correct spacing of the NTC resistor relative to the coil wire.

The NTC resistor can be arranged on the side of a coil formed by the coil wire on which the external contacting thereof can be carried out. Connector pins are used for the external contact. Advantageously, a connecting line back to the pins can be omitted by virtue of the described arrangement of the NTC resistor. Such a connecting line would be required if the NTC resistor were arranged on the opposite side of the coil. Preferably, the NTC resistor is arranged as close as possible to the connector pins.

The ohmic resistance can be formed exclusively or predominantly by a wire. The resistance of a wire can be adjusted without any difficulty by means of its length. What is more, a wire is a cost-effective, light, and space-saving resistor. A wire can be integrated in an extremely space-saving manner into a circuit comprising an electrical conductor with a temperature-dependent electrical resistor that is connected in series with an electrical series resistor, with the electrical series resistor comprising a parallel circuit of an ohmic resistor and an NTC resistor (thermistor). Through a parallel circuit of a purely ohmic resistor, which is formed by a wire, and an NTC resistor, compensation of a temperature-related change in the resistance of a conductor can be achieved in a structurally simple manner.

The wire can have a specific electrical resistance whose value at 600° C. is no more than 20%, preferably no more than 10%, especially preferably no more than 5% over its value at 20° C. As a result, the electrical resistance of the ohmic resistor is nearly temperature-independent.

The wire can be made of or contain constantan. Constantan is an alloy whose specific electrical resistance is supremely temperature-independent. Constantan is a brand name. It refers to an alloy that usually contains about 53-57% copper, about 43-45% nickel, and about 0.5-1.2% manganese. This alloy exhibits an approximately constant specific electrical resistance over large temperature intervals.

The wire can be additionally wound onto the coil formed from the coil wire. This enables the wire to be arranged in an especially space-saving manner in the circuit. Moreover, the wire contributes to the magnetic field of the coil and can strengthen it. The wire can be wound under, over, or next to the coil wire, provided that they are electrically insulated from one another.

The wire can be wound onto a coil support in addition to the coil wire, with the wire being located in its own winding area. The wire—preferably a constantan wire—is not applied as an additional layer onto windings of copper wire, for example; instead, it is given its own winding area on a coil support.

The coil wire can be embodied as copper wire. The coil wire forms the coil and hence the electrical conductor. The temperature-related change in the resistance of copper can be compensated for very well by virtue of the series resistor.

For example, a change in the resistance of the coil can be compensated for very well in the range from 0-140° C., it being possible for the temperature range to be changed through appropriate selection of the components of the series resistor. In this temperature range, the electrical resistance of the coil rises in nearly linear fashion, whereas the total resistance of the series connection composed of coil and series resistor remains nearly constant in this temperature range. The increase in the electrical resistance of the coil or of the coil wire is compensated for by the decrease in the electrical resistance of the series resistor. On the whole, the total resistance remains approximately the same, so that the resulting current through the coil wire remains constant and no substantial loss of the magnetic force of the coil occurs.

Through the use of only two electrical components for the series resistor, a valve is produced in which the influence of temperature on the magnetic force of the coil is as little as possible, with the valve having as few electrical components as possible. Against this background, it is possible to provided only one single coil. This ensures that the valve has as few parts as possible. Elaborate winding processes involving several coils are dispensed with.

The valve can be embodied as an ACF regeneration valve for metering fuel vapors or used as such. Such valves are intended to control the gasoline vapors coming from the tank or an activated carbon filter of the fuel tank ventilation. Hydrocarbons vaporize in the tank of a motor vehicle operated by a gasoline engine. To prevent a pressure increase in the fuel tank, excess air and fuel vapors must be discharged into the surroundings. The fuel vapors can be buffered in an activated carbon canister (ACF) where the hydrocarbons are absorbed. To clean the activated carbon canister, the hydrocarbons can be suctioned out of the activated carbon canister periodically by establishing appropriate pressure conditions and fed to the engine together with the intake air for combustion. A valve of the type described herein can be used to meter the hydrocarbons in the intake air, since it works in a relatively temperature-independent manner and therefore very precisely and reproducibly.

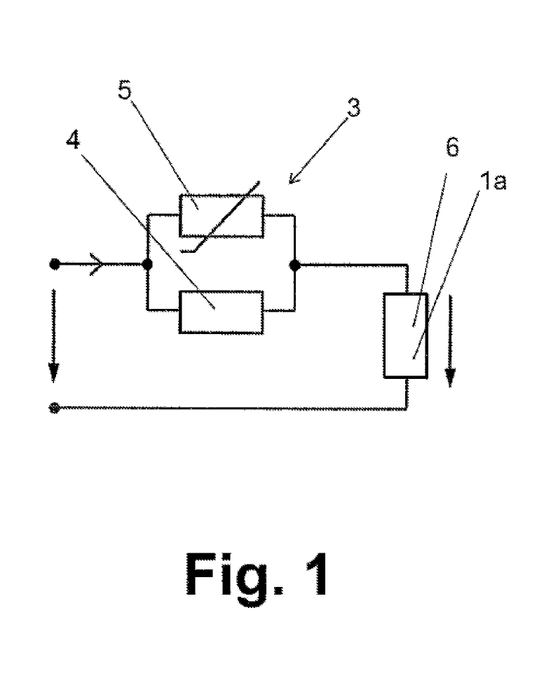

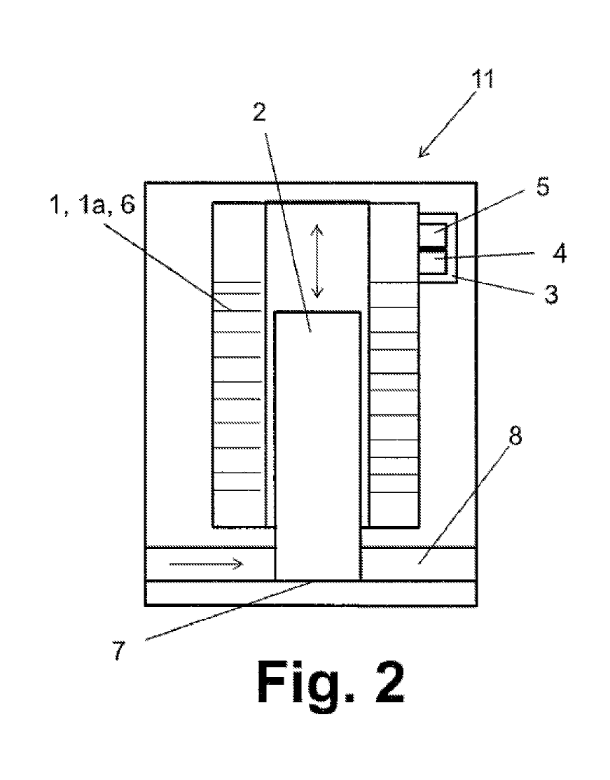

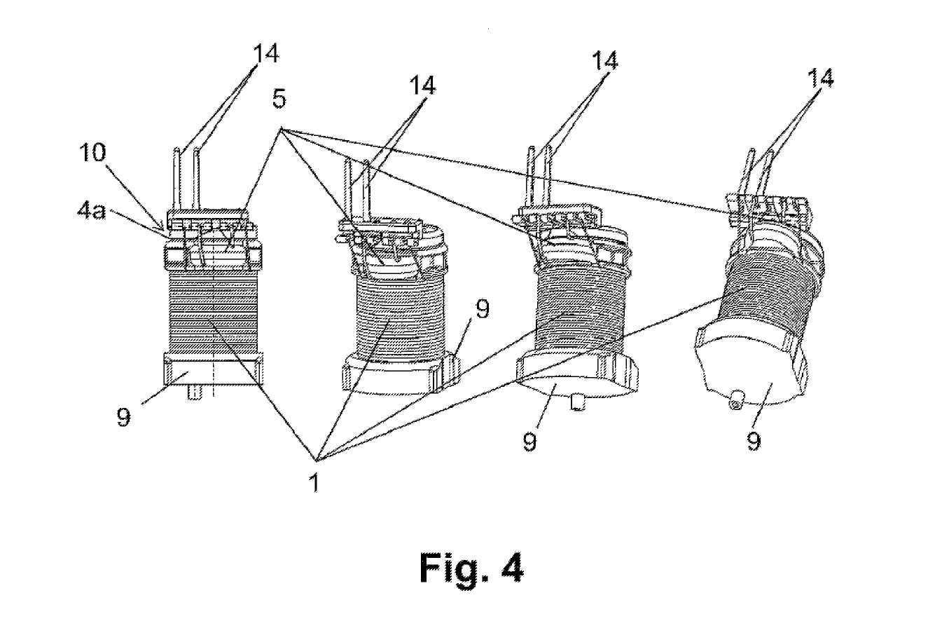

FIG. 1 shows a circuit for use in a valve 11 according to FIG. 2, comprising an electrical conductor 1a with a temperature-dependent electrical resistor 6 that is connected in series to an electrical series resistor 3. The electrical series resistor 3 comprises a parallel circuit of an ohmic resistor 4 and an NTC resistor 5. The ohmic resistor is formed exclusively or predominantly by a wire 4a made of constantan that is shown in FIG. 4.

The electrical conductor 1a is embodied as a wound coil wire 1 that forms a coil and is also shown in FIG. 4. FIG. 1 shows an equivalent circuit diagram of a circuit that is used in a valve 11 according to FIG. 2.

The valve 11 according to FIG. 2 comprises an electromagnetic coil as an electrical conductor 1a that is formed by a wound coil wire 1. The valve 11 further comprises an armature 2, with the armature 2 being actuatable by the magnetic force of the coil when the coil is supplied with current, and with the coil being connected in series to an electrical series resistor 3 according to FIG. 1.

In the equivalent circuit diagram according to FIG. 1, it is shown that the electrical series resistor 3 is a parallel circuit of an ohmic resistor 4, namely a passive electrical resistor, and an NTC resistor 5.

The passive, ohmic resistor is formed exclusively or predominantly by a wire 4a, which is shown in FIG. 4. The wire 4a has a specific electrical resistance whose value at 600° C. is no more than 5% over its value at 20° C. The wire 4a is made of constantan (brand name).

Specifically, the series resistor 3 is formed by the parallel circuit of the ohmic resistor 4 and NTC resistor 5. The electrical resistance of the NTC resistor 5 decreases as the temperature rises.

Only one coil is provided. However, it is also possible for several coils that are connected in series to be provided. The sole coil is connected in series to the series resistor 3. In the equivalent circuit diagram, the coil is represented substitutionally by its electrical resistance 6, namely the electrical resistance 6 of an electrical conductor 1a.

FIG. 2 merely shows schematically that the armature 2 blocks or unblocks a seal seat 7 in order to permit or prevent the flow of material through a line 8.

The armature 2 can carry out an up-and-down movement. This is indicated by the double arrow. The armature 2 is usually pressed by a spring onto the seal seat 7. As a result of the magnetic force of the coil supplied with current, the armature 2 is lifted away from the seal seat 7 against the force of the spring. As soon as there is no longer any current flowing through the coil or coil wire 1, the armature 2 is pressed against by the spring onto the seal seat 7. This process can also be conceivably set up in the converse manner, in which case the valve would be a closer instead of an opener.

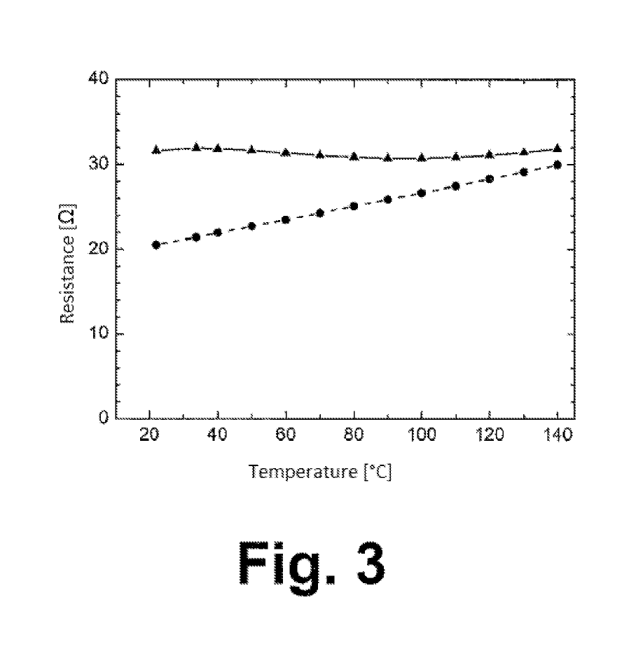

FIG. 3 shows a diagram in which the temperature dependence of the electrical resistance 6 of the coil or of the coil wire 1 or electrical conductor 1a is represented by circular symbols. As the temperature increases, the uncompensated electrical resistance 6 of the coil or coil wire 1 or electrical conductor 1a increases.

In this example, the electrical resistance 6 increases by about 50% of its initial value in the event of a temperature change from 20° C. to 140° C. The electrical resistance 6 of the coil wire 1 increases from about 20 ohm to about 30 ohm.

The temperature-compensated total electrical resistance that results from the sum of the electrical resistances of the coil wire 1 and series resistor 3 of the parallel circuit of ohmic resistor 4 and NTC resistor 5 is approximately constant in the abovementioned temperature range.

The temperature-compensated total resistance fluctuates by only a few percent, preferably no more than 2%, around a mean value. Here, the mean value is about 30 ohm. This is represented by triangular symbols. This value depends very much on the temperature range for which the series resistor 3 is designed.

The series resistance Rv of the parallel circuit is calculated according to the following formula, in which R_{Ω} stands for the purely ohmic resistance 4 and R_{NTC} stands for the NTC resistance 5.

$${R}_{V} = \frac{1}{\frac{1}{{R}_{Ω}} + \frac{1}{{R}_{NTC}}}$$

The temperature-compensated total resistance Rₜₒₜₐₗ composed of parallel circuit and coil wire 1 is calculated according to the following formula, in which R_{coil} stands for the electrical resistance 6 of the coil wire 1 and/or of the electrical conductor 1a.

Rₜₒₜₐₗ=Rᵥ+R_{coil}

FIG. 4 shows a concrete representation of an electromagnetic coil as an electrical conductor 1 a that is formed by a wound coil wire 1. The coil wire 1 is embodied as copper wire.

A wire 4a is wound axially next to the copper wire that has a specific electrical resistance whose value at 600° C. is no more than 5% over its value at 20° C.

The wire 4a is made of constantan. Specifically, the wire 4a is wound here additionally onto a coil support 9, with the wire 4a being located in its own winding area 10.

FIG. 2 shows a valve 11 comprising a circuit, wherein the circuit has an electrical conductor 1 a with a temperature-dependent electrical resistor 6 that is connected in series to an electrical series resistor 3, wherein the electrical series resistor 3 comprises a parallel circuit of an ohmic resistor 4 and an NTC resistor 5, and wherein the electrical conductor 1a comprises a coil wire 1.

Specifically, the electrical conductor 1a is formed by the wound coil wire 1, which, in turn, forms a coil.

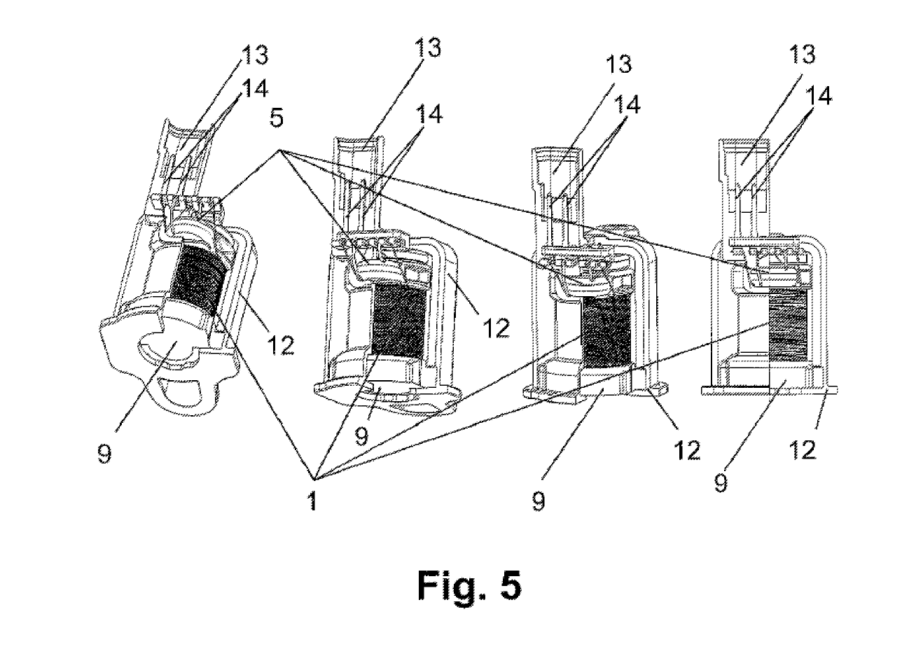

The NTC resistor 5 is arranged so as to be thermally coupled with the coil wire 1. This is shown concretely in FIGS. 4 and 5.

The NTC resistor is spaced apart 0.5 to 1 mm from the coil wire 1.

The ohmic resistor 4 can be formed exclusively or predominantly by the wire 4a. The wire 4a has a specific electrical resistance whose value at 600° C. is no more than 20%, preferably no more than 10%, especially preferably no more than 5% over its value at 20° C. The wire 4a is made of constantan. The wire 4a is wound onto a coil support 9 in addition to the coil wire 1, with the wire 4a being located in its own winding area 10.

FIG. 5 shows that the NTC resistor 5 is integrated into a plastic casing 12 of the magnetic circuit. The plastic casing 12 forms a protective channel 13 for two connector pins 14. External contacting of the coil can be achieved through the connector pins 14.

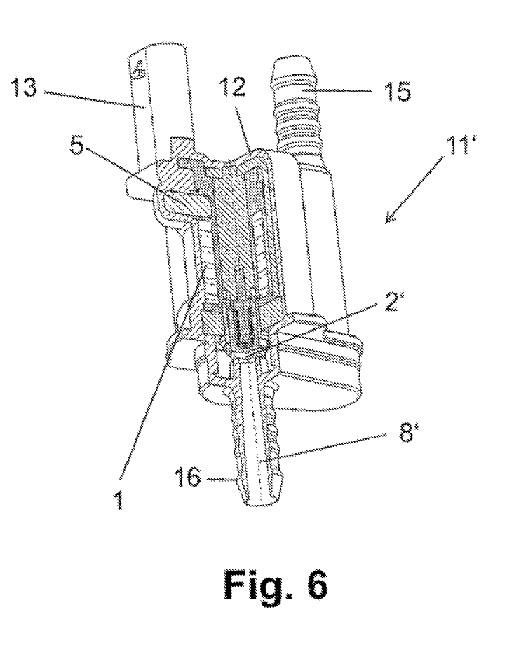

FIG. 6 shows a valve 11′ comprising the previously described circuit (not shown here, however), wherein the circuit has an electrical conductor with a temperature-dependent electrical resistor that is connected in series to an electrical series resistor, wherein the electrical series resistor comprises a parallel circuit of an ohmic resistor and an NTC resistor 5, and wherein the electrical conductor comprises a coil wire 1. The NTC resistor 5 is arranged so as to be thermally coupled with the coil wire 1.

The NTC resistor is spaced apart 0.5 to 1 mm from the coil wire 1. Specifically, the NTC resistor 5 is spaced apart axially from the coil, which is formed by the coil wire 1. The NTC resistor 5 is integrated into a plastic casing 12 of a magnetic circuit. The NTC resistor 5 is arranged on the side of the coil formed by the coil wire 1 on which its external electrical contacting occurs via the two connector pins 14 (not shown). The valve 11′ further comprises two connectors 15, 16 protruding in opposite directions that are parts of a line 8′ that can be blocked by an armature 2′. The valve 11 and the valve 11′ are respectively embodied as ACF regeneration valves for metering fuel vapors.

It is to be understood that the description of the foregoing exemplary embodiment(s) is (are) intended to be only illustrative, rather than exhaustive. Those of ordinary skill will be able to make certain additions, deletions, and/or modifications to the embodiment(s) of the disclosed subject matter without departing from the spirit of the disclosure or its scope.

What is claimed is:

1. A valve comprising: a circuit having an electrical conductor with a temperature-dependent electrical resistance, the electrical conductor being connected in series to an electrical series resistor, wherein the electrical series resistor comprises a parallel circuit of an ohmic resistor and an NTC resistor, and wherein the electrical conductor comprises a coil wire thermally coupled to the NTC resistor.

2. The valve according to claim 1, wherein the NTC resistor is spaced apart 0.5 to 1 mm from the coil wire.

3. The valve according to claim 1, further comprising a magnetic circuit with a plastic casing, and wherein the NTC resistor is integrated into the plastic casing.

4. The valve according to claim 1, wherein the coil wire forms a coil, and wherein the NTC resistor is arranged on a side of the coil which may be connected to an external electrical contact.

5. The valve according to claim 1, wherein the ohmic resistor is formed exclusively by a wire.

6. The valve as set forth in claim 5, wherein the wire has an electrical resistance at 600° C. that is no more than 20% greater than its electrical resistance at 20° C.

7. The valve according to claim 5, wherein the wire is comprised of an alloy comprising copper, nickel and manganese.

8. The valve according to claim 5, further comprising a coil support, and wherein the wire and the coil wire are wound onto the coil support, with the wire being located in its own winding area.

9. The valve according to claim 8, wherein the coil wire is comprised of copper.

10. The valve according to claim 1, wherein the valve is an ACF regeneration valve for metering fuel vapors.

11. The valve according to claim 1, wherein the coil wire forms a coil, and wherein the valve further comprises an armature that is movable between a first position and a second position, and wherein when the coil is provided with current, the coil produces a magnetic force that is operable to move the armature from the first positon to the second position.

12. The valve according to claim 11, wherein the first position is a closed position and the second position is an open position.

13. The valve according to claim 12, further comprising a spring that biases the armature toward the closed position.

14. The valve according to claim 12, further comprising a line segment adapted for connection into a line through which fluid flows, the line segment having a seal seat disposed therein, wherein when the armature is in the closed position, the armature is pressed agains the seal seat, thereby blocking fluid flow through the line segment.

15. The valve according to claim 11, further comprising a plastic casing enclosing the coil, and wherein the NTC resistor is integrated into the plastic casing.
